(19) United States
(12) Patent Application Publication
(10) Pub. No.: US 2022/0219415 A1
(43) Pub. Date: Jul. 14, 2022

(54) AGRICULTURAL BIN COLUMN REPAIR KIT

(71) Applicant: DADCO, Inc. dba RPP Containers, Cincinnati, OH (US)

(72) Inventors: Jeffrey Mitchell, Louisville, KY (US); Eric D. Stein, Harrison, OH (US)

(73) Assignee: DADCO, Inc. dba RPP Containers, Cincinnati, OH (US)

(21) Appl. No.: 17/575,632

(22) Filed: Jan. 13, 2022

Related U.S. Application Data
(60) Provisional application No. 63/136,860, filed on Jan. 13, 2021.

(51) Int. Cl. B29C 73/04; B29C 73/24

(52) U.S. Cl. CPC B29C 73/04; B29C 73/24

(57) ABSTRACT

A simple and easy repair kit to restore the structural integrity of damaged agricultural bins, specifically to repair a corner of a bin. The repair kit consists of two parts: a structural tube and a collar.

### BACKGROUND OF THE INVENTION

### 1. Field of the Invention

The disclosed invention relates to a repair kit for repairing a damaged bin. Specifically, the repair kit can be used to repair an agricultural bin column.

### 2. Description of the Related Art

Large plastic agricultural bins are widely used for harvesting, storing, handling, and shipping of food products. For example, these bins are often used to harvest oranges, potatoes, cantaloupe, and other large-sized produce. These bins require great structural strength as they are stacked to warehouse height containing several hundred pounds in each bin. These bulk bins are designed to be reusable and durable. However, the bins are not indestructible; they can break. These bins are handled in a very rough manner. They are hit by fork trucks, pushed off the back of flatbed trailers, dropped from high distances, and stacked on uneven ground.

These bins are frequently transported by flatbed trucks and often fall or are dropped off the trucks, landing on the lowest corners of the bin fully loaded with agricultural produce. The sharp, sudden impact can cause the bin to break, ruining the inherent structural integrity and column strength of the bin. The bins may also be damaged by forklift impact, by the sharp leading edge of the fork impacting the leg of the bin, again ruining the inherent structural integrity of the bin. The corner of the bin can be damaged to the point that the bin is unsafe, unusable, or useless.

The current solution to damaged bins is to remove the compromised bin from service and ship it to a remote facility, possibly in another state. If possible, the bin may be repaired by a plastic welding technique, though often major sections of the bin may have broken away, rendering the bin useless. Also, plastic welding requires costly equipment and training. Further, repairing the bin by welding does not restore the stack strength of the container and poses a safety risk to farmers and others using the bin.

Often, these bins are accidently damaged in the critical corners that provide stacking strength. The corners of the bins are designed to withstand the extremely high stacked loads of harvested fruit and vegetables for processing or warehousing. When these critical structural elements are compromised, the containers are rendered useless or pose a safety concern if used without repair.

The bins are very expensive and if they get damaged it is a big expense to the harvest operation. Accordingly, there is a need for a bin repair kit which is quick, easy to use, convenient, and allows for a high-quality, durable on-site bin repair such that shipping a bin to a remote facility is not required. There is a desire for a repair kit which is inexpensive and which costs less than buying a replacement bin.

### SUMMARY OF THE INVENTION

Disclosed herein is column repair kit for a damaged agricultural bin, wherein the kit comprises a structural tube, and wherein the structural tube is sized to fit within a column. This simple and easy repair kit can restore the structural integrity of damaged agricultural bins, specifically to repair a corner of a bin.

### BRIEF DESCRIPTION OF THE FIGURES

The drawings and detailed description that follow are intended to be merely illustrative and are not intended to limit the scope of the invention as contemplated by the inventors. The detailed description of specific embodiments of the present invention can be best understood when read in conjunction with the following drawings.

FIG. 1 shows an exemplary agricultural bin having no breakage;

FIG. 2 shows a close-up of a corner of a bin suffering from an impact failure in the form of a fracture;

FIG. 3 shows a close-up of a foot of a bin suffering from an impact failure in the form of a split failure;

FIG. 4 shows an exemplary bin repair kit;

FIG. 5 shows a top view of a portion of a structural tube as molded;

FIG. 6 shows a top view of a structural tube as assembled; and

FIG. 7 shows a perspective view of an exemplary collar.

### DETAILED DESCRIPTION OF THE INVENTION

The inventor conceived of a novel column repair kit that, for the purpose of illustration, is disclosed herein as applied in the context of agricultural bins. While the disclosed applications of the inventor's column repair kit satisfy a long-felt but unmet need in the art of agricultural bins, it should be understood that the inventor's column repair kit is not limited to being implemented in the precise manners set forth herein, but could be implemented in other manners without undue experimentation by those of ordinary skill in the art in light of this disclosure. For instance, the column repair kit could also work for other types of plastic bins, not just those commonly referred to as agricultural bins. Accordingly, the examples set forth herein should be understood as being illustrative only, and should not be treated as limiting.

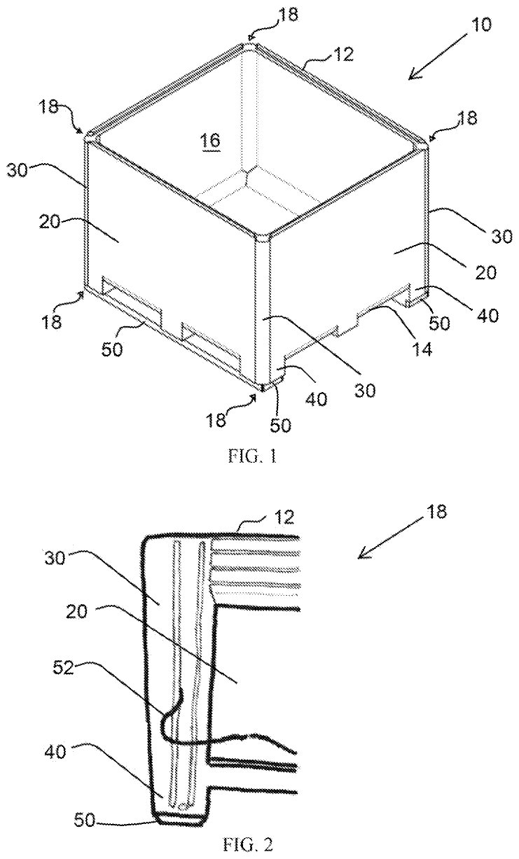

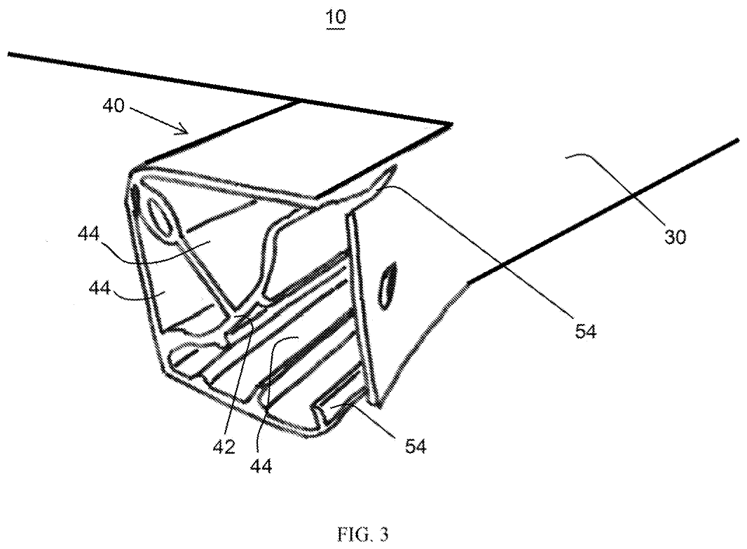

An example of an exemplary agricultural bin 10 of the present invention is shown in FIG. 1. The agricultural bin comprises a top edge 12, a bottom edge 14, a cavity 16, corners 18, sidewalls 20, columns 30, legs 40, and feet 50. Various portions of the bin may be at least partially hollow inside. For instance, legs 40 may comprise one or more inner profiles 42 which define one or more hollow portions 44. Feet 50 can be forklift straps. While an agricultural bin 10 may encounter various types of damage, FIGS. 2 and 3 show two of the most common types of impact failures. FIG. 2 shows a close-up of a corner 18 of a bin 10 suffering from an impact failure in the form of a fracture 52 on a leg 40. FIG. 3 shows a close-up of a leg 40 of a bin 10 suffering from an impact failure in the form of a split failure 54. The leg 40 comprises an interior profile 42 defining a hollow portion 44. The present invention provides quick and easy repair of an agricultural bin 10 in the field by means of a repair kit 100.

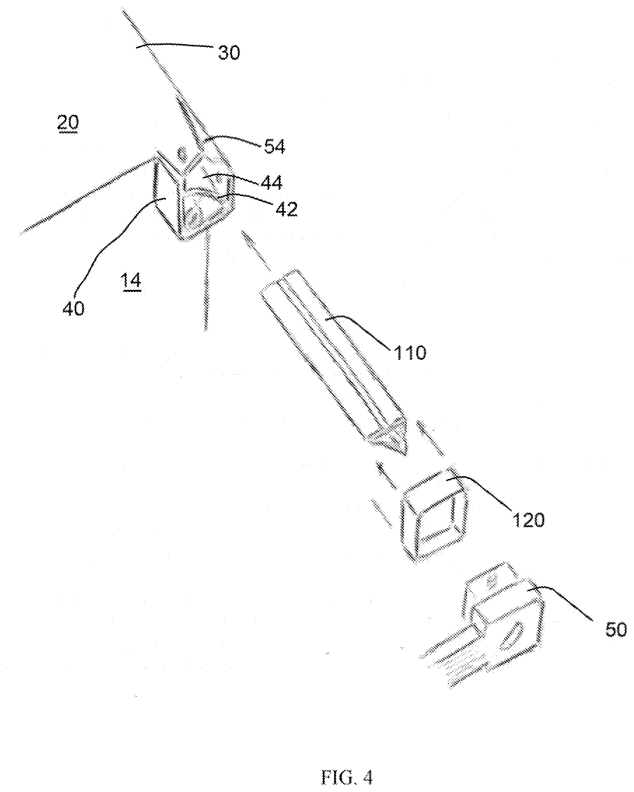

As shown in FIG. 4, the column repair kit 100 comprises two parts: a structural tube 110 that fits precisely inside a hollow 44 leg 40 of a damaged bin 10, and a collar 120 (if necessary) to restore the structural integrity of the lowest edge of the leg 40. The tube 110 provides the column 30 strength of the compromised leg 40 by restoring the top-to-bottom 12, 14 vertical strength and replicating the original, proven, and time-tested geometry of the original bin leg 40. If needed, the collar 120 returns the lowest edge of the leg 40 to its original profile. No special skills or tools are required to perform the repair. Instructions provided with or on the structural tube 110 may state that no special skills or tools are required to perform the repair. The structural tube 110 is inserted into the leg 40 and up the column 30 of the bin 10 once the feet 50 of the bin 10 are removed. If the collar 120 is required, it is fit over the outside of the leg 40 and then the feet 50 are reinstalled on the bottom 14 of the bin 10.

These repair-kit parts may be injection molded, extruded, or compression molded and may be made from a variety of plastic or metal materials (or a combination thereof). In a preferred embodiment, the structural tube 110 is molded from high-impact polypropylene. This material was chosen for the tensile strength and the ability to feature a living hinge 112 for injection molding simplicity. In a preferred embodiment, the collar 120 is made of stainless steel for rust protection, or powder coated painted steel for the same desired result at a lower cost. However, the invention could be made with other materials and using other methods and may be used with or without a living hinge 112.

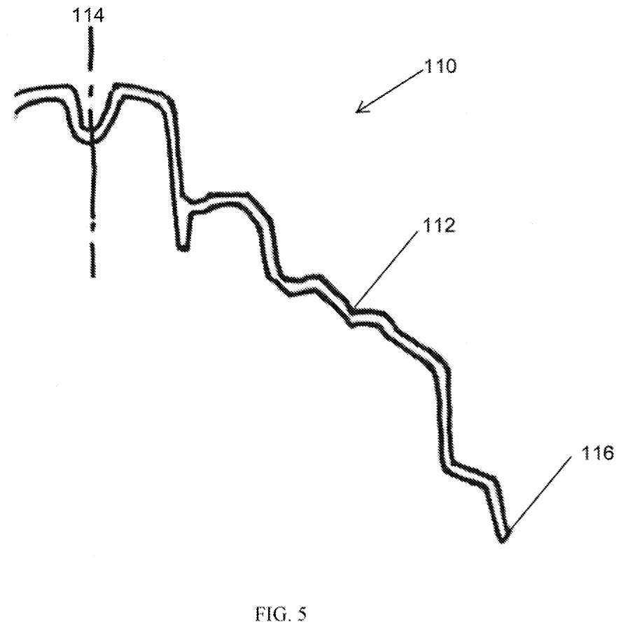

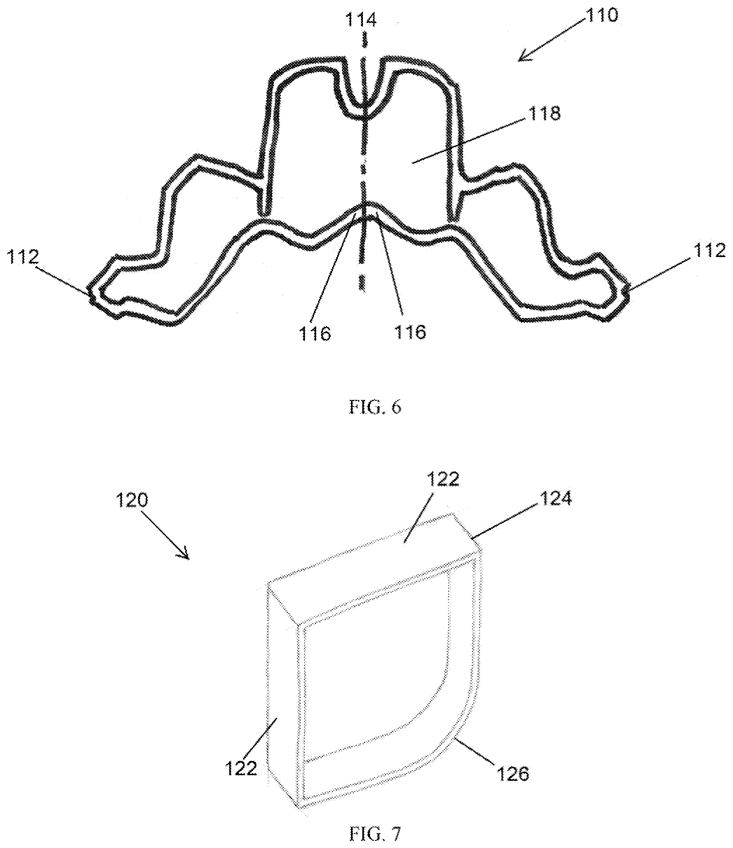

The structural tube 110 is molded relatively flat with two living hinges 112, one on either side of a centerline 114. In a preferred embodiment, each living hinge 112 is located closer to an end 116 of the tube 110 than to the centerline 114, as shown in FIGS. 5 and 6. In another embodiment, a living hinge may be located at or near the center point between the centerline and the end of the tube. In still another embodiment, a living hinge may be located closer to the centerline than the end of the tube. The structural tube can be any length as long as it fits within the column 30. In a preferred embodiment, the structural tube 110 is longer than a leg 40.

As shown in FIG. 6, when folded along the living hinges 112, the two ends 116 of the tube 110 meet at the centerline 114. This operation forms the final shape 118 of the structural tube 110. The final shape 118 is designed to replicate the interior profile 42 of the leg 40 of the bin 10. The structural tube 110 thus replicates the interior 44 of the hollow leg 40 using the length, width and height dimensions of the leg interior profile 42 to act as a structural replacement for the damaged leg 40 of the bin 10. Instructions may be provided by molding instructions onto the structural tube for this component and the collar since the operation is straightforward and relatively simple. There may be other methods and materials used to manufacture the structural tube. As originally conceived, a living hinge was not considered for the structural tube; instead, a solid molded hollow tube was thought to be the best solution. But, by utilizing a living hinge vs a molded hollow tube, considerable cost savings in tooling may be achieved. The structural tube may also be manufactured using a combination of both a living hinge and an extruded tube. While a living hinge structural tube 110 is described and claimed, it is also within the scope of the invention to create a column repair kit comprising a molded hollow tube.

Often a bin is accidently dropped from a great height, landing on a lowest corner of the bin. This can occur in the field or in a warehouse. The impact can cause the plastic material to split where the foot is inserted into the leg of the bin. If this area has split, the feet will not stay and lock in place. A collar 120 can restore the geometry of the bin in this area. Metal is chosen as often the plastic on the bin that has split has enough retained memory, where it split, to act as a very strong spring. Plastic may be used for the collar, but the resiliency of most plastics cannot overcome the spring effect of the split on the broken bin. Steel, either stainless steel or powder coated steel, has the tensile strength to overcome this spring effect to return the bin geometry to its original shape. This allows the components that snap inside the hollow leg, such as the aforementioned feet, to be reinstalled as originally designed.

The collar 120 comprises sides 122 which meet at corners. A corner may comprise a generally 90 degree angle, a less than about 90 degree angle, or a more than about 90 degree angle. In a preferred embodiment, as shown in FIG. 7, a collar 120 comprises four sides 122 which are generally straight, forming three 90-degree angle corners. The fourth corner 126 is rounded. In other embodiments, the collar may be designed to best fit the shape of the leg 40.

In a preferred embodiment, the collar 120 is constructed of metal (stainless steel or powder-coated painted steel for rust protection) to restore the lowest edge of the leg 40 to its original geometry so the feet 50 that snap in place can be restored. This enables the feet 50 (as they are referred to, essentially, in the illustrated preferred embodiment, they are forklift straps) to be snapped in place into the legs 40. In concert with the structural tube 110, these components return the bin 10 to the full functionality of a new bin at minimal cost. The collar 120 may be made using different materials.

One or more structural tubes 110 may be delivered to a user in a first, unfolded position. This enables more efficient shipping and storing. The user can then configure structural tubes 110 as needed into their folded final shape 118. For instance, an owner of many agricultural bins may wish to keep a large stack of unfolded structural tubes handy. Having unfolded tubes allows the owner to devote less space to each tube and thereby have more on hand to facilitate fast and easy bin repairs as needed.

While the invention describes repairing a damaged bin, there may be situations where the described structural tube and/or collar may be used to provide additional stability to a bin which is not damaged.

While specific embodiments of the inventor's novel invention were illustrated and described herein, variations and modifications may be made by those skilled in the art without departing from the scope of this disclosure. The present disclosure is for purposes of illustration and not of limitation; it may take many forms other than those explicitly disclosed herein. As such, the claims below shall be read to include all obvious variations and modifications that may be within the spirit of this invention.

What is claimed is:

1. A column repair kit for a damaged agricultural bin, wherein the kit comprises:
a structural tube,
wherein the structural tube is sized to fit within a column.

2. The repair kit of claim 1, wherein the structural tube comprises at least one living hinge.

3. The repair kit of claim 1, further comprising a collar.

4. A method for repairing a damaged agricultural bin comprising the steps of:
a. providing a bin having one or more columns and one or more feet, wherein the feet generally align with the columns,
b. removing a foot of the bin,
c. inserting a structural tube into a column of the bin, and
d. reinstalling the foot on the bottom of the bin.

5. The method of claim 4, wherein the column comprises a leg, further comprising the step of fitting a collar over the outside of the leg.

6. A structural tube comprising a living hinge which is sized appropriately for insertion into a hollow leg of an agricultural bin.
